(19) United States
(12) Patent Application Publication
(10) Pub. No.: US 2024/0380222 A1
(43) Pub. Date: Nov. 14, 2024

(54) CIRCUIT AND METHOD FOR SUPPRESSING POWER SUPPLY STARTING SURGE, CHARGING APPARATUS, AND STORAGE MEDIUM

(71) Applicant: Changchun Jetty Automotive Technology Co., Ltd., Changchun, Jilin (CN)

(72) Inventors: Chao Wang, Jilin (CN); Guoqing CAO, Jilin (CN)

(21) Appl. No.: 18/688,241

(22) PCT Filed: Aug. 15, 2022
(86) PCT No.: PCT/CN2022/112468

§ 371 Date: Feb. 29, 2024

(30) Foreign Application Priority Data
Aug. 31, 2021 (CN) 202111014899.9

(51) Int. Cl. H02J 7/00

(52) U.S. Cl. CPC H02J 7/00304; H02J 7/0047

(57) ABSTRACT

The present disclosure provides a circuit and method for suppressing a power supply starting surge, a charging apparatus, and a storage medium. The circuit for suppressing a power supply starting surge includes: a power supply module, a relay, and a variable resistance. The relay is connected in parallel to the variable resistance and then connected between an external power supply and the power supply module. According to the present disclosure, the variable resistance is connected in parallel to both ends of the relay, so that a power supply starting surge can be effectively suppressed, the power supply module is controlled to output an appropriate power supply voltage, and normal operation of components in the circuit can be protected.

The present disclosure claims priority to Chinese Patent Application No. 202111014899.9, entitled “CIRCUIT AND METHOD FOR SUPPRESSING POWER SUPPLY STARTING SURGE, CHARGING APPARATUS, AND STORAGE MEDIUM” as filed on Aug. 31, 2021, which is hereby incorporated by reference in its entirety.

### TECHNICAL FIELD

The present disclosure relates to the technical field of electric power, in particular to a circuit, a method for suppressing a power supply starting surge, a charging apparatus, and a storage medium.

### BACKGROUND

The safety of high-current power supply modules has attracted more attention, with the popularization of high-current charging technology for electric vehicles. In the power supply circuit of the existing high-current power supply module, the relay is completely controlled by the hardware control circuit consisting of various components, the relay cannot work properly due to damages to any component in the hardware control circuit, which thus may lead to damages to the power supply module or other components. Moreover, a high surge current is generated when a switch is powered on. Therefore, a circuit structure, which prevents a surge current, needs to be provided at an input terminal of the power supply.

Therefore, how to avoid direct damages to the power supply module or other components due to relay failure and how to suppress the surge current have become problems to be urgently solved by those skilled in the art.

### SUMMARY

An embodiment of the present disclosure provides a circuit for suppressing a power supply starting surge to solve the technical problem that in the existing power supply circuit, the relay is completely controlled by the hardware circuit, and the relay cannot function properly due to damages to any component in the hardware control circuit. The circuit for suppressing a power supply starting surge includes: a power supply module, a relay and a variable resistance, and the relay is connected in parallel to the variable resistance and then connected between an external power supply and the power supply module.

Further, the circuit for suppressing a power supply starting surge in the embodiment of the present disclosure further includes: a voltage detection module and a microcontroller, in which an input terminal of the voltage detection module is connected to an output terminal of the power supply module for detecting an output voltage of the power supply module; an input terminal of the microcontroller is connected to an output terminal of the voltage detection module, and the microcontroller is configured to control whether to activate the relay based on a detection result of the voltage detection module, thereby controlling whether the variable resistance is connected to a power supply circuit from the external power supply to the power supply module.

Furthermore, the circuit for suppressing a power supply starting surge in the embodiment of the present disclosure further includes a transistor, of which an input terminal is connected to an output terminal of the microcontroller, and of which an output terminal is connected to an input terminal of the relay, in which the microcontroller is configured to control turn-on and turn-off of the transistor according to the detection result of the voltage detection module, thereby controlling whether to activate the relay and whether the variable resistance is connected to the power supply circuit from the external power supply to the power supply module.

Furthermore, the microcontroller is configured to: control the transistor to be turned on, drive the relay to be turned on, and short-circuit the variable resistance, so that the power supply module outputs a voltage of the external power supply at full power, in a case where the output voltage of the power supply module is higher than a reference voltage; and control the transistor to be turned off, and drive the relay to be turned off, so that an input voltage of the external power supply is input to the power supply module through the variable resistance, in a case where an output voltage of the power supply module is lower than the reference voltage.

An embodiment of the present disclosure also provides a charging apparatus to solve the technical problem that in the existing power supply circuit, the relay is completely controlled by the hardware circuit, and the relay cannot function properly due to damages to any component in the hardware control circuit. The charging apparatus includes: any one of the circuits for suppressing a power supply starting surge.

An embodiment of the present disclosure also provides a motor vehicle, including the charging apparatus.

An embodiment of the present disclosure provides a method for suppressing a power supply starting surge to solve the technical problem that in the existing power supply circuit, the relay is completely controlled by the hardware circuit, the relay cannot function properly due to damages to any component in the hardware control circuit. The method for suppressing a power supply starting surge includes: detecting, by the voltage detection module, an output voltage of the power supply module; controlling, by the microcontroller, whether to activate the relay based on a detection result of the voltage detection module, and controlling whether the variable resistance is connected to a power supply circuit from the external power supply to the power supply module.

Further, the method for suppressing a power supply starting surge in the embodiment of the present disclosure further includes: controlling, by the microcontroller, turn-on and turn-off of the transistor according to the detection result of the voltage detection module, and controlling whether to activate the relay, and whether the variable resistance is connected to the power supply circuit from the external power supply to the power supply module.

Furthermore, the method for suppressing a power supply starting surge in the embodiment of the present disclosure further includes: controlling, by the microcontroller, the transistor to be turned on, driving the relay to be turned on, and short-circuiting the variable resistance, so that the power supply module outputs a voltage of the external power supply at full power, in a case where an output voltage of the power supply module is higher than a reference voltage; and controlling, by the microcontroller, the transistor to be turned off, and driving the relay to be turned off, so that an input voltage of the external power supply is input through the variable resistance to the power supply module, in a case where the output voltage of the power supply module is lower than the reference voltage.

An embodiment of the present disclosure also provides a computer-readable storage medium to solve the technical problem that in the existing power supply circuit, the relay is completely controlled by the hardware circuit, and the relay cannot function properly due to damages to any component in the hardware control circuit. The computer-readable storage medium stores a computer program for implementing the method for suppressing a power supply starting surge.

An embodiment of the present disclosure also provides a motor vehicle, including the charging apparatus.

The circuit, method for suppressing a power supply starting surge, the charging apparatus, the storage medium, and the motor vehicle provided in the embodiments of the present disclosure connect a variable resistance in parallel to both ends of the relay, so that a power supply starting surge current can be effectively suppressed, and the power supply module is controlled to output an appropriate power supply voltage, and thus normal operation of components in the circuit can be protected.

Further, based on a combination of software control and hardware circuits, according to the voltage detection result, turn-on and turn-off of the relay are controlled by the microcontroller and the transistor, the number of components required for relay control is reduced, and the probability that the relay does not function properly can be reduced, so as to avoid damages to the power supply module or other components in the circuit due to relay failure. Applying the circuit for suppressing a power supply starting surge provided in the embodiment of the present disclosure to the charging apparatus can not only suppress the surge current caused by power startup, but also improve the stability and durability of a surge protection circuit of the charging apparatus.

### BRIEF DESCRIPTION OF THE DRAWINGS

In order to more clearly demonstrate the technical solutions in the embodiments of the present disclosure or the prior art, drawings that need to be used in the description in the embodiments or the prior art will be simply introduced below. Obviously, the drawings in the description below are only some embodiments of the present disclosure, and other drawings may also be obtained by those skilled in the art based on these drawings without creative efforts.

FIG. 1 is a schematic block diagram illustrating a circuit for suppressing a power supply starting surge provided in an embodiment of the present disclosure;

FIG. 2 is a schematic diagram illustrating a circuit for suppressing a power supply starting surge provided in an embodiment of the present disclosure;

FIG. 3 is a flowchart illustrating a method for suppressing a power supply starting surge provided in an embodiment of the present disclosure; and

FIG. 4 is a flowchart illustrating an alternative method for suppressing a power supply starting surge provided in an embodiment of the present disclosure.

### DETAILED OF THE EMBODIMENTS

In order to more clearly describe the objective, technical solutions and advantages in the embodiments of the present disclosure, the drawings to be used in the description of the embodiments will be introduced in further detail below. The schematic embodiments and descriptions of the present disclosure are used herein to demonstrate the present disclosure, but are not intended to be a limitation of the present disclosure.

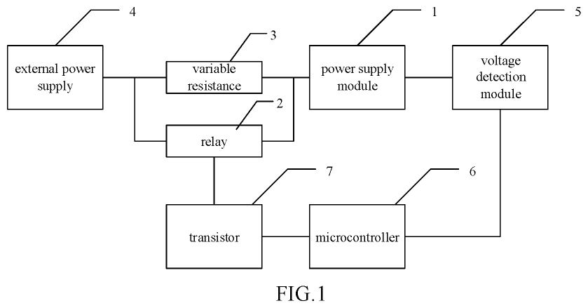

An embodiment of the present disclosure provides a circuit for suppressing a power supply starting surge. FIG. 1 is a schematic diagram illustrating a circuit for suppressing a power supply starting surge provided in an embodiment of the present disclosure. As illustrated in FIG. 1, the circuit for suppressing a power supply starting surge includes: a power supply module 1, a relay 2 and a variable resistance 3. The relay 2 is connected in parallel to the variable resistance 3 and then connected between an external power supply 4 and the power supply module 1.

It should be noted that in the circuit for suppressing a power supply starting surge provided in the embodiment of the present disclosure, the circuit can have different startup instantaneous impulse currents (surge suppression value) and surge duration by setting a resistance value of the variable resistance 3. In an embodiment, a resistance adjustment range of the variable resistance is 3Ω-20Ω. In an embodiment, if the resistance adjustment range of the variable resistance is 3Ω-20Ω, the startup instantaneous impulse currents of the circuit can be less than or equal to 73 A. More preferably, the resistance adjustment range of the variable resistance is 5Ω-10Ω. In an embodiment, if the resistance adjustment range of the variable resistance is 5Ω-10Ω, the startup instantaneous impulse currents of the circuit can be less than or equal to 44 A, and the surge duration of the circuit can be less than or equal to 4 s. Surge protection can be achieved by limiting the power supply starting surge current value and duration within a certain range. More specifically, as can be seen, the present disclosure does not limit the resistance value of the variable resistance 3 in the adjustment process. In various embodiments, the resistance value of the variable resistance 3 can be 5Ω, 6Ω, 7Ω . . . 10Ω; the corresponding surge suppression value is 44 A, 36.6 A, 31.4 A . . . 22 A, that is, a product of the resistance value of the variable resistor 3 and the surge suppression value is a mains voltage of 220 V.

In order to realize the software control of the relay 2, in an embodiment, the circuit for suppressing a power supply starting surge in the embodiment of the present disclosure further includes: a voltage detection module 5 and a microcontroller 6; in which an input terminal of the voltage detection module 5 is connected to an output terminal of the power supply module 1 for detecting an output voltage of the power supply module 1; an input terminal of the microcontroller 6 is connected to an output terminal of the voltage detection module 5, and the microcontroller 6 is configured to control whether to activate the relay 2 based on a detection result of the voltage detection module 5, thereby controlling whether the variable resistance 3 is connected to a power supply circuit from the external power supply 4 to the power supply module 1.

Further, in order to better control the relay 2, in an embodiment, the circuit for suppressing a power supply starting surge in the embodiment of the present disclosure further includes a transistor 7, of which an input terminal is connected to an output terminal of the microcontroller 6, and of which an output terminal is connected to an input terminal of the relay 2, in which the microcontroller 6 is configured to control turn-on and turn-off of the transistor 7 according to the detection result of the voltage 20 detection module 5, thereby controlling whether to activate the relay 2, and whether the variable resistance 3 is connected to the power supply circuit from the external power supply 4 to the power supply module 1.

It should be noted that the wording “activate” in “to activate the relay 2” in the embodiment of the present disclosure refers to driving the relay 2 to be turned on, whereas a state “being not activated” of the relay 2 can be understood that the relay 2 is in a turned-off state.

According to the voltage detection result of the voltage detection module 5, the microcontroller 6 in the embodiment of the present disclosure controls turn-on and turn-off of the relay 2 by the microcontroller 6 and the transistor 7, so as to ensure the normal operation of the relay to avoid direct damages to the power supply module and other components in the circuit.

Alternatively, the microcontroller 6 in the embodiment of the present disclosure adopts a single-chip microcomputer.

In an embodiment, the microcontroller 6 in the embodiment of the present disclosure can be configured to control the transistor 7 to be turned on, drive the relay 2 to be turned on and short-circuit the variable resistance 3, so that the power supply module 1 outputs a voltage of the external power supply 4 at full power, in a case where the output voltage of the power supply module 1 is higher than a reference voltage; control the transistor 7 to be turned off, and drive the relay 2 to be turned off, so that an input voltage of the external power supply 4 is input to the power supply module 1 through the variable resistance 3, in a case where an output voltage of the power supply module 1 is lower than the reference voltage.

In the embodiment, in the case where the output voltage of the power supply module 1 is higher than the reference voltage, it indicates that the power supply module 1 is in an operating state of charging outwards, in this case, the variable resistance 3 needs to be short-circuited, so that the power supply module 1 can output the voltage of the external power supply 4 at full power, and improve the charging efficiency of the power supply module 1; in the case where the output voltage of the power supply module 1 is lower than the reference voltage, it indicates that the power supply module 1 stops charging outwards, in this case, the variable resistance 3 needs to be connected, so that the input voltage of the external power supply 4 is input to the power supply module 1 through the variable resistance 3, so that the power supply module 1 outputs an appropriate voltage, in order to prevent various components in the power supply module 1 from being damaged.

It should be noted that the circuit for suppressing a power supply starting surge provided in the embodiment of the present disclosure can be used in various high-power output devices (including but not limited to charging apparatuses for electric vehicles) to accomplish surge protection.

Therefore, in an embodiment, the circuit for suppressing a power supply starting surge provided in the embodiment of the present disclosure can be placed at a front end of the charging apparatus, and between the external power supply and the charging apparatus, in order to protect the charging apparatus from being damaged.

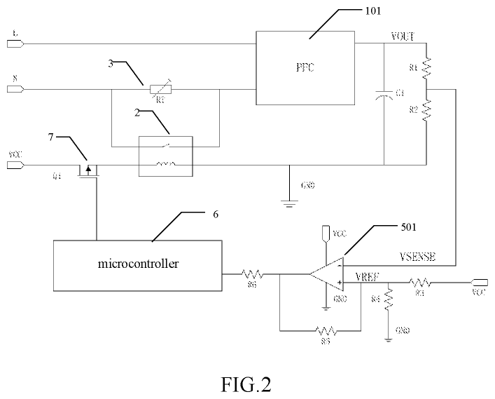

Next, referring to FIG. 2, in the circuit for suppressing a power supply starting surge according to the embodiment of the present disclosure, the power supply module 1 may include: a PFC module 101 and a PFC capacitor C1 for power factor correction, in which an input terminal of the voltage detection module is connected to an output terminal of the PFC module 101 for detecting an output voltage of the PFC module 101; a first terminal of the PFC capacitor C1 is connected to the output terminal of the PFC module 101, a second terminal of the PFC capacitor C1 is connected to a ground terminal GND. In the embodiment of the present disclosure, the voltage of the external power supply is corrected by the PFC module 101 and the PFC capacitor C1, the power supply efficiency of the external power supply can be improved; when the divided voltage value of the output voltage of the PFC module is higher than a set voltage value (reference voltage value) by detecting the divided voltage value of the output voltage of the PFC module, the single-chip microcomputer drives the relay to be turned on, and the PFC module starts to output voltage normally.

In an embodiment, as illustrated in FIG. 2, in the circuit for suppressing a power supply starting surge in the embodiment of the present disclosure, the voltage detection module 5 includes: a first resistance R1, a second resistance R2, and an operational amplifier 501, in which a first terminal of the first resistance R1 is connected to the output terminal of the PFC module, a second terminal of the first resistance R1 is connected to a first terminal of the second resistance R2, and a second terminal of the second resistance R2 is connected to a ground terminal GND; a terminal of the first resistance R1 connected to the second resistance R2 is connected to a negative input terminal of the operational amplifier 501, an output terminal of the operational amplifier 501 is connected to the microcontroller 6, and a positive input terminal of the operational amplifier 501 is connected to a reference voltage divider circuit.

Alternatively, the number of the first resistance R1 and the second resistance R2 may be one or more, in order to guarantee the accuracy of the collected voltage value.

As illustrated in FIG. 2, the reference voltage divider circuit is used to provide a reference voltage (in FIG. 2, VREF refers to the reference voltage and VSENSE refers to the output voltage detected by the voltage detection module). Specifically, the reference voltage divider circuit includes: a third resistance R3 and a fourth resistance R4, in which a first terminal of the third resistance R3 is connected to a positive terminal VCC of the external power supply, a second terminal of the third resistance R3 is connected to a first terminal of the fourth resistance R4, a second terminal of the fourth resistance R4 is connected to the ground terminal, and a terminal of the third resistance R3 connected to the fourth resistance R4 is connected to the positive input terminal of the operational amplifier 501. In the embodiment of the present disclosure, the terminal of the third resistance R3 connected to the fourth resistance R4 is connected to the negative input terminal of the operational amplifier to form a voltage detection circuit.

In this embodiment, VREF=VCC×R4/(R3+R4); VSENSE=VOUT×R2/(R1+R2).

The single-chip microcomputer in the embodiment of the present disclosure is connected to the gate of the transistor, and VCC is connected to the drain of the transistor 7. In an embodiment, the single-chip microcomputer is configured such that the operational amplifier 501 outputs a high level, and the single-chip microcomputer outputs a high level; the operational amplifier 501 outputs a low level, and the single-chip microcomputer outputs a low level. Certainly, in other embodiments, the single-chip microcomputer can be configured such that the operational amplifier 501 outputs a high level, and the single-chip microcomputer outputs a low level; the operational amplifier 501 outputs a low level, and the single-chip microcomputer outputs a high level.

When VSENSE<VREF, the operational amplifier 501 outputs a high level, the single-chip microcomputer outputs a high level, the transistor is turned off, and the relay 2 is turned off; when VSENSE>VREF, when the operational amplifier 501 outputs a low level, the single-chip microcomputer outputs a low level, the transistor 7 is turned on and the relay 2 is turned on. That is, when the operational amplifier 501 outputs a high level, the relay 2 is turned off, and the PFC capacitor is charged through RT at the input voltage, so that the surge current is inversely proportional to the RT1 resistance, the RT with an appropriate resistance value can be chosen and the surge current can be controlled within an acceptable range; when the operational amplifier 501 outputs a low level, the relay 2 is turned on, and an impedance of a large current path can be reduced by short-circuiting the RT1, and the power system can achieve output at full power.

Further, a fifth resistance R5 is connected between the positive input terminal and the output terminal of the operational amplifier 501, and a sixth resistance R6 is connected between the output terminal of the operational amplifier 501 and the microprocessor 3, in which the fifth resistance R5 is a feedback resistance connected between an output pin of the operational amplifier 501 and a forward pin, which can eliminate zero drift; and the sixth resistance R6 can prevent the outputs from short-circuiting, in order to protect the operational amplifier 501.

In an embodiment, the transistor 7 of the present disclosure can be a field effect transistor, in which a gate of the field effect transistor is connected to the microcontroller, and a drain of the field effect transistor is connected to the positive terminal of the external power supply, and the source of the field effect transistor is connected to the relay. The field effect transistor has advantages such as high input resistance, low noise, low power consumption, large dynamic range, easy integration, no secondary breakdown phenomenon, and wide safe working area.

In another embodiment, the transistor 7 of the present disclosure may be a triode, in which a base of the triode is connected to the microcontroller, and a collector of the triode is connected to the positive terminal of the external power supply, and an emitter of the triode is connected to the relay. The triode has a current amplification effect that the triode can control a great change in the collector current with a small change in the base current in essence.

It should be noted that the field effect transistor and the triode in the embodiment of the present disclosure can be replaced without changing the wiring method, and the specific parameters are selected according to the relay 2.

Based on the same inventive concept, an embodiment of the present disclosure also provides a charging apparatus. The charging apparatus includes a circuit for suppressing a power supply starting surge according to any one of the above claims. Since the charging apparatus solves the problem on a similar principle to that of the circuit for suppressing a power supply starting surge, refer to the implementation of the circuit for suppressing a power supply starting surge for the implementation of the charging apparatus, where repetitions will not be described here anymore.

It should be noted that the charging apparatus provided in the embodiment of the present disclosure refers to a high-power charging apparatus, which may be but not limited to a charging apparatus for an electric vehicle.

Based on the same inventive concept, an embodiment of the present disclosure also provides a method for suppressing a power supply starting surge, as mentioned in the embodiment below. Since this method solves the problem on a similar principle to that of the circuit for suppressing a power supply starting surge, refer to the implementation of the circuit for suppressing a power supply starting surge for the implementation of this method, where repetitions will not be described here anymore.

FIG. 3 is a flowchart illustrating a method for suppressing a power supply starting surge provided in an embodiment of the present disclosure. As illustrated in FIG. 3, the method includes the steps of:

S301, detecting, by a voltage detection module, an output voltage of a power supply module; and

S302, controlling, by a microcontroller, whether to activate a relay based on a detection result of the voltage detection module, and controlling whether the variable resistance is connected to a power supply circuit from the external power supply to the power supply module.

In an embodiment, the S302 can control, by the microcontroller, turn-on and turn-off of the transistor according to the detection result of the voltage detection module, thereby controlling whether to activate the relay, and whether the variable resistance is connected to a power supply circuit from the external power supply to the power supply module.

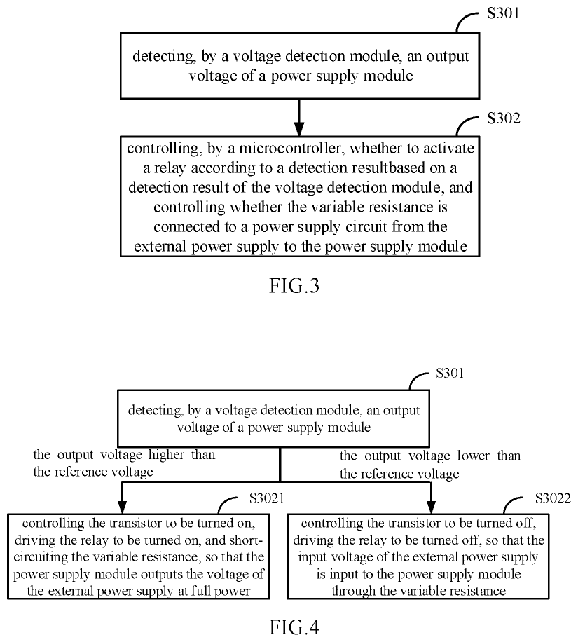

Further, in an embodiment, as illustrated in FIG. 4, the S302 can be specifically implemented in the steps as follows:

S3021, controlling the transistor to be turned on, driving the relay to be turned on, and short-circuiting the variable resistance, so that the power supply module outputs the voltage of the external power supply at full power, in a case where the output voltage of the power supply module is higher than the reference voltage; and

S3022, controlling the transistor to be turned off, driving the relay to be turned off, so that the input voltage of the external power supply is input to the power supply module through the variable resistance, in a case where the output voltage of the power supply module is lower than the reference voltage.

Based on the same inventive concept, an embodiment of the present disclosure also provides a computer-readable storage medium to solve the technical problem that in the existing power supply circuit, the relay is completely controlled by the hardware circuit, and the relay cannot function properly due to damages to any component in the hardware control circuit. The computer-readable storage medium stores a computer program for implementing the method for suppressing a power supply starting surge.

Based on the same inventive concept, an embodiment of the present disclosure also provides a motor vehicle, including the charging apparatus in the embodiment.

To sum up, the circuit, method for suppressing a power supply starting surge, the charging apparatus and the storage medium provided in the embodiments of the present disclosure connect the variable resistance in parallel to both ends of the relay, so that a power supply starting surge can be effectively suppressed, the power supply module is controlled to output an appropriate power supply voltage, and normal operation of components in the circuit can be protected.

Further, based on a combination of software control and hardware circuits, according to the voltage detection result, turn-on and turn-off of the relay are controlled by the microcontroller and transistor, the number of components required for relay control is reduced, and the probability that the relay does not function properly can be reduced, so as to avoid damages to the power supply module or other components in the circuit due to relay failure. Applying the circuit for suppressing a power supply starting surge provided in the embodiment of the present disclosure to the charging apparatus can improve the stability and durability of a surge protection circuit of the charging apparatus.

Those skilled in the art shall understand that the embodiments of the present disclosure may be provided as a method, a system, or a computer program product. Accordingly, the present disclosure can take the form of an embodiment of hardware alone, an embodiment of software alone, or an embodiment combining software with hardware. Further, the present disclosure may take the form of a computer program product embodied on one or more computer-usable storage media (including but not limited to a magnetic-disk memory, a CD-ROM, an optical memory) having a computer-usable program code.

The present disclosure is described with reference to a flowchart and/or a block diagram of method, device (system), and computer program product according to embodiments of the present disclosure. It should be understood that each procedure and/or block in the flowchart and/or block diagram, and a combination of procedures and/or blocks in the flowchart and/or block diagram can be realized by computer program instructions. These computer program instructions may be provided to a general-purpose computer, a special-purpose computer, an embedded processor, or a processor of other programmable data processing equipment to produce a machine such that the instructions executed by the computer or the processor of other programmable data processing equipment produce a device for realizing the functions specified in one or more procedures of the flowchart and/or one or more blocks of the block diagram.

These computer program instructions may also be stored in a computer-readable memory capable of directing a computer or other programmable data processing equipment to function in a specific manner, such that the instructions stored in the computer-readable memory produce an article of manufacture including an instruction device that realizes functions specified in one or more procedures of the flowchart and/or one or more blocks of the block diagram.

These computer program instructions can also be loaded onto a computer or other programmable data processing equipment, such that a series of operational steps are performed on the computer or other programmable equipment to produce a computer-implemented process, thus the instructions executed on the computer or other programmable equipment provide steps for implementing the functions specified in one or more procedures of the flowchart and/or one or more blocks of the block diagram.

The embodiments described above have further described the objective, technical solutions and advantageous effects of the present disclosure in detail. It should be understood that those described above are just the embodiments of the present disclosure, rather than limitations thereto. Any amendment, equivalent substitution, improvement within the spirit and principle of the present disclosure should fall within the protection scope of the present disclosure.

1. A circuit for suppressing a power supply starting surge, including: a power supply module, a relay and a variable resistance, wherein the relay is connected in parallel to the variable resistance and then connected between an external power supply and the power supply module.

2. The circuit for suppressing a power supply starting surge according to claim 1, further including: a voltage detection module and a microcontroller, wherein an input terminal of the voltage detection module is connected to an output terminal of the power supply module for detecting an output voltage of the power supply module; an input terminal of the microcontroller is connected to an output terminal of the voltage detection module, and the microcontroller is configured to control whether to activate the relay based on a detection result of the voltage detection module, thereby controlling whether the variable resistance is connected to a power supply circuit from the external power supply to the power supply module.

3. The circuit for suppressing a power supply starting surge according to claim 2, further including: a transistor, of which an input terminal is connected to an output terminal of the microcontroller, and of which an output terminal is connected to an input terminal of the relay, wherein the microcontroller is configured to control turn-on and turn-off of the transistor based on the detection result of the voltage detection module, thereby controlling whether to activate the relay and whether the variable resistance is connected to the power supply circuit from the external power supply to the power supply module.

4. The circuit for suppressing a power supply starting surge according to claim 3, wherein the microcontroller is configured to: control the transistor to be turned on, drive the relay to be turned on, and short-circuit the variable resistance, so that the power supply module outputs a voltage of the external power supply at full power, in a case where the output voltage of the power supply module is higher than a reference voltage; and control the transistor to be turned off and drive the relay to be turned off, so that an input voltage of the external power supply is input to the power supply module through the variable resistance, in a case where the output voltage of the power supply module is lower than the reference voltage.

5. The circuit for suppressing a power supply starting surge according to claim 2, wherein the power supply module includes: a PFC module and a PFC capacitor for power factor correction, in which an input terminal of the voltage detection module is connected to an output terminal of the PFC module for detecting an output voltage of the PFC module; a first terminal of the PFC capacitor is connected to the output terminal of the PFC module, and a second terminal of the PFC capacitor is connected to a ground terminal.

6. The circuit for suppressing a power supply starting surge according to claim 5, wherein the voltage detection module includes: a first resistance, a second resistance, and an operational amplifier, in which a first terminal of the first resistance is connected to the output terminal of the PFC module, a second terminal of the first resistance is connected to a first terminal of the second resistance, and a second terminal of the second resistance is connected to the ground terminal; a terminal of the first resistance connected to the second resistance is connected to a negative input terminal of the operational amplifier, an output terminal of the operational amplifier is connected to the microcontroller, and a positive input terminal of the operational amplifier is connected to a reference voltage divider circuit, in which the reference voltage divider circuit is used to provide a reference voltage.

7. The circuit for suppressing a power supply starting surge according to claim 6, wherein the reference voltage divider circuit includes: a third resistance and a fourth resistance, in which a first terminal of the third resistance is connected to a positive terminal of the external power supply, a second terminal of the third resistance is connected to a first terminal of the fourth resistance, a second terminal of the fourth resistance is connected to the ground terminal, and a terminal of the third resistance connected to the fourth resistance is connected to the positive input terminal of the operational amplifier.

8. The circuit for suppressing a power supply starting surge according to claim 3, wherein the transistor is a triode, in which a base of the triode is connected to the microcontroller, and a collector of the triode is connected to the positive terminal of the external power supply, and an emitter of the triode is connected to the relay.

9. The circuit for suppressing a power supply starting surge according to claim 3, wherein the transistor is a field effect transistor, in which a gate of the field effect transistor is connected to the microcontroller, and a drain of the field effect transistor is connected to the positive terminal of the external power supply, and a source of the field effect transistor is connected to the relay.

10. The circuit for suppressing a power supply starting surge according to claim 2, wherein the microcontroller is a single-chip microcomputer.

11. The circuit for suppressing a power supply starting surge according to claim 1, wherein a resistance adjustment range of the variable resistance is 3Ω-20Ω.

12. The circuit for suppressing a power supply starting surge according to claim 1, wherein the resistance adjustment range of the variable resistance is 5Ω-10Ω.

13. The circuit for suppressing a power supply starting surge according to claim 12, wherein a surge suppression value of the circuit is varied by adjusting the variable resistance, and the surge suppression value is less than or equal to 44 A.

14. The circuit for suppressing a power supply starting surge according to claim 13, wherein a surge duration of the circuit is less than or equal to 4 s.

15. A charging apparatus, including: a circuit for suppressing a power supply starting surge according to claim 1.

16. A method for suppressing a power supply starting surge applied to the circuit for suppressing a power supply starting surge according to claim 2, including: detecting, by the voltage detection module, an output voltage of the power supply module; controlling, by the microcontroller, whether to activate the relay based on a detection result of the voltage detection module, and controlling whether the variable resistance is connected to a power supply circuit from the external power supply to the power supply module.

17. The method for suppressing a power supply starting surge according to claim 16, further including: controlling, by the microcontroller, turn-on and turn-off of the transistor according to the detection result of the voltage detection module, and controlling whether to activate the relay, and whether the variable resistance is connected to the power supply circuit from the external power supply to the power supply module.

18. The method for suppressing a power supply starting surge according to claim 17, further including: controlling, by the microcontroller, the transistor to be turned on, driving the relay to be turned on, and short-circuiting the variable resistance, so that the power supply module outputs a voltage of the external power supply at full power, in a case where an output voltage of the power supply module is higher than a reference voltage; and controlling, by the microcontroller, the transistor to be turned off and driving the relay to be turned off, so that an input voltage of the external power supply is input through the variable resistance to the power supply module, in a case where the output voltage of the power supply module is lower than the reference voltage.

19. (canceled)

20. (canceled)

21. The charging apparatus according to claim 15, further including: a voltage detection module and a microcontroller, wherein an input terminal of the voltage detection module is connected to an output terminal of the power supply module for detecting an output voltage of the power supply module; an input terminal of the microcontroller is connected to an output terminal of the voltage detection module, and the microcontroller is configured to control whether to activate the relay based on a detection result of the voltage detection module, thereby controlling whether the variable resistance is connected to a power supply circuit from the external power supply to the power supply module.

22. The charging apparatus according to claim 21, further including: a transistor, of which an input terminal is connected to an output terminal of the microcontroller, and of which an output terminal is connected to an input terminal of the relay, wherein the microcontroller is configured to control turn-on and turn-off of the transistor based on the detection result of the voltage detection module, thereby controlling whether to activate the relay and whether the variable resistance is connected to the power supply circuit from the external power supply to the power supply module.
